(19) United States
(12) Patent Application Publication
(10) Pub. No.: US 2013/0169490 A1
(43) Pub. Date: Jul. 4, 2013

(54) Antenna With Switchable Inductor Low-Band Tuning

(71) Applicants: Mattia Pascolini, Campbell, CA (US); Robert W. Schlub, Cupertino, CA (US); Nanbo Jin, Sunnyvale, CA (US); Matthew A. Mow, Los Altos, CA (US); Hongfei Hu, Santa Clara, CA (US); Joshua G. Nickel, San Jose, CA (US)

(72) Inventors: Mattia Pascolini, Campbell, CA (US); Robert W. Schlub, Cupertino, CA (US); Nanbo Jin, Sunnyvale, CA (US); Matthew A. Mow, Los Altos, CA (US); Hongfei Hu, Santa Clara, CA (US); Joshua G. Nickel, San Jose, CA (US)

(21) Appl. No.: 13/343,657

(22) Filed: Jan. 4, 2012

(51) Int. Cl. H01Q 1/24; H01Q 1/48

(52) U.S. Cl. 343/702; 343/722

(57) ABSTRACT

Electronic devices may be provided that contain wireless communications circuitry. The wireless communications circuitry may include radio-frequency transceiver circuitry and antennas. An antenna may be formed from an antenna resonating element arm and an antenna ground. The antenna resonating element arm may have a shorter portion that resonates at higher communications band frequencies and a longer portion that resonates at lower communications band frequencies. A short circuit branch may be coupled between the shorter portion of the antenna resonating element arm and the antenna ground. A series-connected inductor and switch may be coupled between the longer portion of the antenna resonating element arm and the antenna ground. An antenna feed branch may be coupled between the antenna resonating element arm and the antenna ground at a location that is between the short circuit branch and the series-connected inductor and switch.

### BACKGROUND

This relates generally to electronic devices, and more particularly, to antennas for electronic devices with wireless communications circuitry.

Electronic devices such as portable computers and cellular telephones are often provided with wireless communications capabilities. For example, electronic devices may use long-range wireless communications circuitry such as cellular telephone circuitry to communicate using cellular telephone bands. Electronic devices may use short-range wireless communications circuitry such as wireless local area network communications circuitry to handle communications with nearby equipment. Electronic devices may also be provided with satellite navigation system receivers and other wireless circuitry.

To satisfy consumer demand for small form factor wireless devices, manufacturers are continually striving to implement wireless communications circuitry such as antenna components using compact structures. At the same time, it may be desirable to include conductive structures in an electronic device such as metal device housing components. Because conductive structures can affect radio-frequency performance, care must be taken when incorporating antennas into an electronic device that includes conductive structures. Moreover, care must be taken to ensure that the antennas and wireless circuitry in a device are able to exhibit satisfactory performance over a range of operating frequencies.

It would therefore be desirable to be able to provide improved wireless communications circuitry for wireless electronic devices.

### SUMMARY

Electronic devices may be provided that contain wireless communications circuitry. The wireless communications circuitry may include radio-frequency transceiver circuitry and antennas. An antenna may be formed from an antenna resonating element arm and an antenna ground. The antenna resonating element arm may be formed from a segment of a peripheral conductive housing member in an electronic device.

The antenna resonating element arm may have a shorter portion that resonates at higher communications band frequencies and a longer portion that resonates at lower communications band frequencies. A short circuit branch may be coupled between the shorter portion of the antenna resonating element arm and the antenna ground. A series-connected inductor and switch may be coupled between the longer portion of the antenna resonating element arm and the antenna ground. An antenna feed branch may be coupled between the antenna resonating element arm and the antenna ground at a location along the antenna resonating element arm that is between the short circuit branch and the series-connected inductor and switch.

The switch may be adjusted to configure the antenna to resonate at different frequencies. When the switch is closed, the antenna may be configured to cover a higher portion of the lower communications bands and the higher communications band. When the switch is open, the antenna may be configured to cover a lower portion of the lower communications bands and the higher communications band. Control circuitry within an electronic device may adjust the switch in real time so that the antenna covers desired frequencies of operation.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device with wireless communications circuitry in accordance with an embodiment of the present invention.

FIG. 2 is a schematic diagram of an illustrative electronic device with wireless communications circuitry in accordance with an embodiment of the present invention.

FIG. 3 is a top view of an illustrative electronic device of the type shown in FIG. 1 in which antennas may be formed using conductive housing structures such as portions of a peripheral conductive housing member in accordance with an embodiment of the present invention.

FIG. 4 is a circuit diagram showing how an antenna in the electronic device of FIG. 1 may be coupled to radio-frequency transceiver circuitry in accordance with an embodiment of the present invention.

FIG. 5 is a diagram of an illustrative antenna having an antenna resonating element of the type that may be formed form a segment of a peripheral conductive housing member and that has portions that support communications in low and high bands in accordance with an embodiment of the present invention.

FIG. 6A is a diagram of an illustrative antenna of the type shown in FIG. 5 that has been provided with a matching circuit and in which a main resonating element arm has been coupled to ground using an inductor in accordance with an embodiment of the present invention.

FIG. 6B is a graph in which antenna performance for an antenna configuration of the type shown in FIG. 6A has been plotted as a function of frequency in accordance with an embodiment of the present invention.

FIG. 7A is a diagram of an illustrative antenna of the type shown in FIG. 6A in which the shunt inductor has been removed in accordance with an embodiment of the present invention.

FIG. 7B is a graph in which antenna performance for an antenna configuration of the type shown in FIG. 7A has been plotted as a function of frequency in accordance with an embodiment of the present invention.

FIG. 8A is a diagram of an illustrative dual-band antenna having a tunable low band response in accordance with an embodiment of the present invention.

FIG. 8B is a graph in which antenna performance for an antenna configuration of the type shown in FIG. 8A has been plotted as a function of frequency showing how antenna response can be tuned by opening and closing the switch of FIG. 8A in accordance with an embodiment of the present invention.

### DETAILED DESCRIPTION

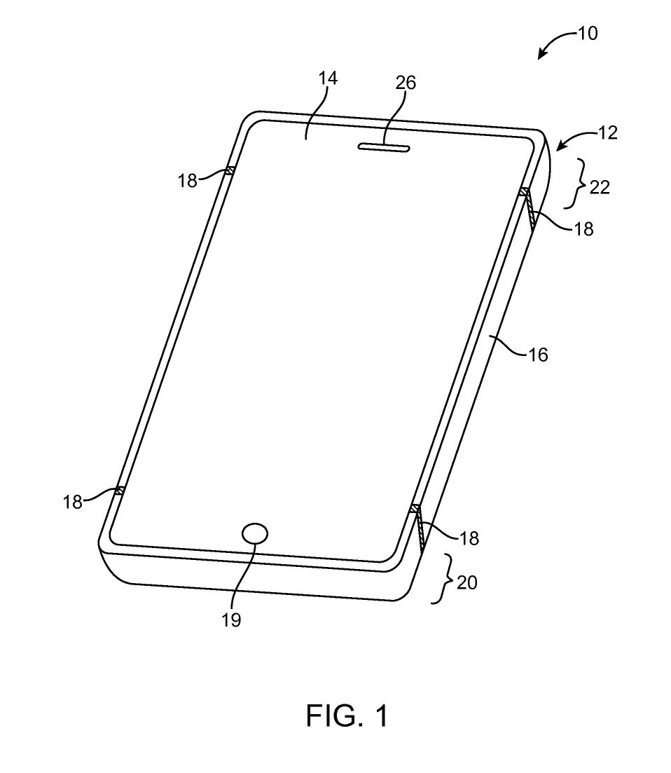

Electronic devices such as electronic device 10 of FIG. 1 may be provided with wireless communications circuitry. The wireless communications circuitry may be used to support wireless communications in multiple wireless communications bands. The wireless communications circuitry may include one or more antennas.

The antennas can include loop antennas, inverted-F antennas, strip antennas, planar inverted-F antennas, slot antennas, hybrid antennas that include antenna structures of more than one type, or other suitable antennas. Conductive structures for the antennas may, if desired, be formed from conductive electronic device structures. The conductive electronic device structures may include conductive housing structures. The housing structures may include a peripheral conductive member that runs around the periphery of an electronic device. The peripheral conductive member may serve as a bezel for a planar structure such as a display, may serve as sidewall structures for a device housing, and/or may form other housing structures. Gaps in the peripheral conductive member may be associated with the antennas.

Electronic device 10 may be a portable electronic device or other suitable electronic device. For example, electronic device 10 may be a laptop computer, a tablet computer, a somewhat smaller device such as a wrist-watch device, pendant device, headphone device, earpiece device, or other wearable or miniature device, a cellular telephone, or a media player. Device 10 may also be a television, a set-top box, a desktop computer, a computer monitor into which a computer has been integrated, or other suitable electronic equipment.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material. In other situations, housing 12 or at least some of the structures that make up housing 12 may be formed from metal elements.

Device 10 may, if desired, have a display such as display 14. Display 14 may, for example, be a touch screen that incorporates capacitive touch electrodes. Display 14 may include image pixels formed from light-emitting diodes (LEDs), organic LEDs (OLEDs), plasma cells, electrowetting pixels, electrophoretic pixels, liquid crystal display (LCD) components, or other suitable image pixel structures. A cover glass layer may cover the surface of display 14. Buttons such as button 19 may pass through openings in the cover glass. The cover glass may also have other openings such as an opening for speaker port 26.

Housing 12 may include a peripheral member such as member 16. Member 16 may run around the periphery of device 10 and display 14. In configurations in which device 10 and display 14 have a rectangular shape, member 16 may have a rectangular ring shape (as an example). Member 16 or part of member 16 may serve as a bezel for display 14 (e.g., a cosmetic trim that surrounds all four sides of display 14 and/or helps hold display 14 to device 10). Member 16 may also, if desired, form sidewall structures for device 10 (e.g., by forming a metal band with vertical sidewalls surrounding the periphery of device 10, etc.).

Member 16 may be formed of a conductive material and may therefore sometimes be referred to as a peripheral conductive member, peripheral conductive housing member, or conductive housing structures. Member 16 may be formed from a metal such as stainless steel, aluminum, or other suitable materials. One, two, or more than two separate structures (e.g., segments) may be used in forming member 16.

It is not necessary for member 16 to have a uniform cross-section. For example, the top portion of member 16 may, if desired, have an inwardly protruding lip that helps hold display 14 in place. If desired, the bottom portion of member 16 may also have an enlarged lip (e.g., in the plane of the rear surface of device 10). In the example of FIG. 1, member 16 has substantially straight vertical sidewalls. This is merely illustrative. The sidewalls of member 16 may be curved or may have any other suitable shape. In some configurations (e.g., when member 16 serves as a bezel for display 14), member 16 may run around the lip of housing 12 (i.e., member 16 may cover only the edge of housing 12 that surrounds display 14 and not the rear edge of housing 12 of the sidewalls of housing 12).

Display 14 may include conductive structures such as an array of capacitive electrodes, conductive lines for addressing pixel elements, driver circuits, etc. Housing 12 may include internal structures such as metal frame members, a planar housing member (sometimes referred to as a midplate) that spans the walls of housing 12 (i.e., a substantially rectangular member that is welded or otherwise connected between opposing sides of member 16), printed circuit boards, and other internal conductive structures. These conductive structures may be located in the center of housing 12 under display 14 (as an example).

In regions 22 and 20, openings may be formed within the conductive structures of device 10 (e.g., between peripheral conductive member 16 and opposing conductive structures such as conductive housing structures, a conductive ground plane associated with a printed circuit board, and conductive electrical components in device 10). These openings may be filled with air, plastic, and other dielectrics. Conductive housing structures and other conductive structures in device 10 may serve as a ground plane for the antennas in device 10. The openings in regions 20 and 22 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element from the ground plane, or may otherwise serve as part of antenna structures formed in regions 20 and 22.

In general, device 10 may include any suitable number of antennas (e.g., one or more, two or more, three or more, four or more, etc.). The antennas in device 10 may be located at opposing first and second ends of an elongated device housing, along one or more edges of a device housing, in the center of a device housing, in other suitable locations, or in one or more of such locations. The arrangement of FIG. 1 is merely illustrative.

Portions of member 16 may be provided with gap structures. For example, member 16 may be provided with one or more gaps such as gaps 18, as shown in FIG. 1. The gaps may be filled with dielectric such as polymer, ceramic, glass, air, other dielectric materials, or combinations of these materials. Gaps 18 may divide member 16 into one or more peripheral conductive member segments. There may be, for example, two segments of member 16 (e.g., in an arrangement with two gaps), three segments of member 16 (e.g., in an arrangement with three gaps), four segments of member 16 (e.g., in an arrangement with four gaps, etc.). The segments of peripheral conductive member 16 that are formed in this way may form parts of antennas in device 10.

In a typical scenario, device 10 may have upper and lower antennas (as an example). An upper antenna may, for example, be formed at the upper end of device 10 in region 22. A lower antenna may, for example, be formed at the lower end of device 10 in region 20. The antennas may be used separately to cover identical communications bands, overlapping communications bands, or separate communications bands. The antennas may be used to implement an antenna diversity scheme or a multiple-input-multiple-output (MIMO) antenna scheme.

Antennas in device 10 may be used to support any communications bands of interest. For example, device 10 may include antenna structures for supporting local area network communications, voice and data cellular telephone communications, global positioning system (GPS) communications or other satellite navigation system communications, Bluetooth° communications, etc.

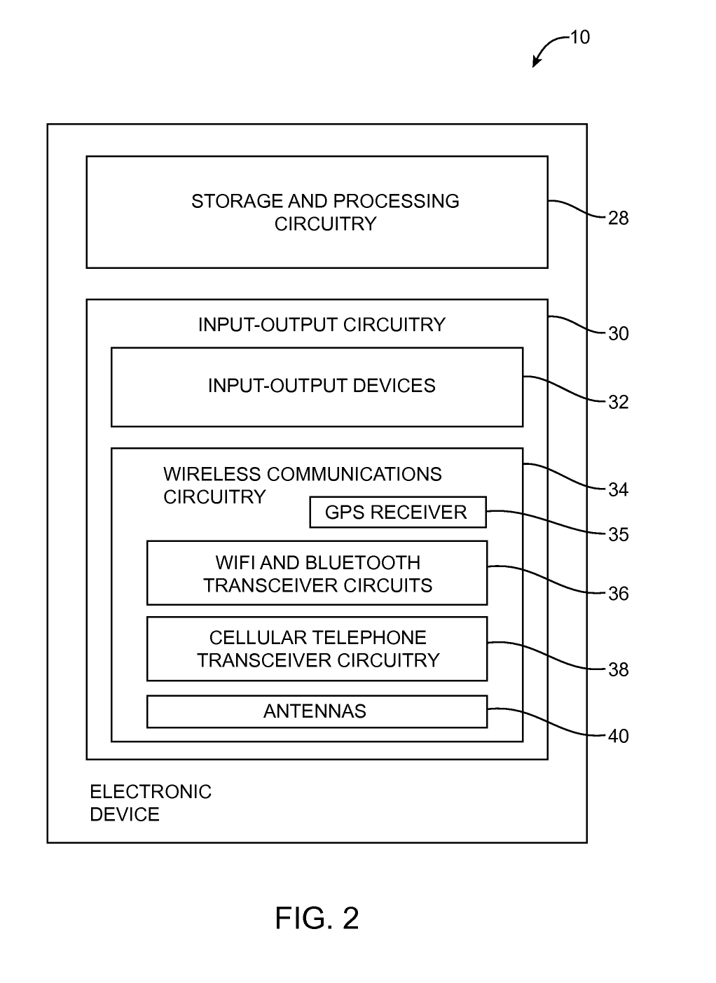

A schematic diagram of an illustrative configuration that may be used for electronic device 10 is shown in FIG. 2. As shown in FIG. 2, electronic device 10 may include control circuitry such as storage and processing circuitry 28. Storage and processing circuitry 28 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in storage and processing circuitry 28 may be used to control the operation of device 10. The processing circuitry may be based on one or more microprocessors, microcontrollers, digital signal processors, baseband processors, power management units, audio codec chips, application specific integrated circuits, etc.

Storage and processing circuitry 28 may be used to run software on device 10, such as internet browsing applications, voice-over-internet-protocol (VoIP) telephone call applications, email applications, media playback applications, operating system functions, etc. To support interactions with external equipment, storage and processing circuitry 28 may be used in implementing communications protocols. Communications protocols that may be implemented using storage and processing circuitry 28 include internet protocols, wireless local area network protocols (e.g., IEEE 802.11 protocols—sometimes referred to as WiFi®), protocols for other short-range wireless communications links such as the Bluetooth° protocol, cellular telephone protocols, etc.

Circuitry 28 may be configured to implement control algorithms that control the use of antennas in device 10. For example, circuitry 28 may perform signal quality monitoring operations, sensor monitoring operations, and other data gathering operations and may, in response to the gathered data and information on which communications bands are to be used in device 10, control which antenna structures within device 10 are being used to receive and process data and/or may adjust one or more switches, tunable elements, or other adjustable circuits in device 10 to adjust antenna performance. As an example, circuitry 28 may control which of two or more antennas is being used to receive incoming radio-frequency signals, may control which of two or more antennas is being used to transmit radio-frequency signals, may control the process of routing incoming data streams over two or more antennas in device 10 in parallel, may tune an antenna to cover a desired communications band, etc. In performing these control operations, circuitry 28 may open and close switches, may turn on and off receivers and transmitters, may adjust impedance matching circuits, may configure switches in front-end-module (FEM) radio-frequency circuits that are interposed between radio-frequency transceiver circuitry and antenna structures (e.g., filtering and switching circuits used for impedance matching and signal routing), may adjust switches, tunable circuits, and other adjustable circuit elements that are formed as part of an antenna or that are coupled to an antenna or a signal path associated with an antenna, and may otherwise control and adjust the components of device 10.

Input-output circuitry 30 may be used to allow data to be supplied to device 10 and to allow data to be provided from device 10 to external devices. Input-output circuitry 30 may include input-output devices 32. Input-output devices 32 may include touch screens, buttons, joysticks, click wheels, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input-output devices 32 and may receive status information and other output from device 10 using the output resources of input-output devices 32.

Wireless communications circuitry 34 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications).

Wireless communications circuitry 34 may include satellite navigation system receiver circuitry such as Global Positioning System (GPS) receiver circuitry 35 (e.g., for receiving satellite positioning signals at 1575 MHz) or satellite navigation system receiver circuitry associated with other satellite navigation systems. Transceiver circuitry 36 may handle wireless local area network communications. For example, transceiver circuitry 36 may handle 2.4 GHz and 5 GHz bands for WiFi® (IEEE 802.11) communications and may handle the 2.4 GHz Bluetooth° communications band. Circuitry 34 may use cellular telephone transceiver circuitry 38 for handling wireless communications in cellular telephone bands such as bands in frequency ranges of about 700 MHz to about 2200 MHz or bands at higher or lower frequencies. Wireless communications circuitry 34 can include circuitry for other short-range and long-range wireless links if desired. For example, wireless communications circuitry 34 may include wireless circuitry for receiving radio and television signals, paging circuits, etc. In WiFi® and Bluetooth° links and other short-range wireless links, wireless signals are typically used to convey data over tens or hundreds of feet. In cellular telephone links and other long-range links, wireless signals are typically used to convey data over thousands of feet or miles.

Wireless communications circuitry 34 may include one or more antennas 40. Antennas 40 may be formed using any suitable antenna types. For example, antennas 40 may include antennas with resonating elements that are formed from loop antenna structure, patch antenna structures, inverted-F antenna structures, closed and open slot antenna structures, planar inverted-F antenna structures, helical antenna structures, strip antennas, monopoles, dipoles, hybrids of these designs, etc. Different types of antennas may be used for different bands and combinations of bands. For example, one type of antenna may be used in forming a local wireless link antenna and another type of antenna may be used in forming a remote wireless link.

If desired, one or more of antennas 40 may be provided with tunable circuitry. The tunable circuitry may include, for example, switching circuitry based on one or more switches. The switching circuitry may, for example, include a switch that can be placed in an open or closed position. When control circuitry 28 of device 10 places the switch in its open position, an antenna may exhibit a first frequency response. When control circuitry 28 of device 10 places the antenna in its closed position, the antenna may exhibit a second frequency response. As an example, antenna 40 may exhibit both a low band response and a high band response. Adjustment of the state of the switch may be used to tune the low band response of the antenna without appreciably affecting the high band response. The ability to adjust the low band response of the antenna may allow the antenna to cover communications frequencies of interest.

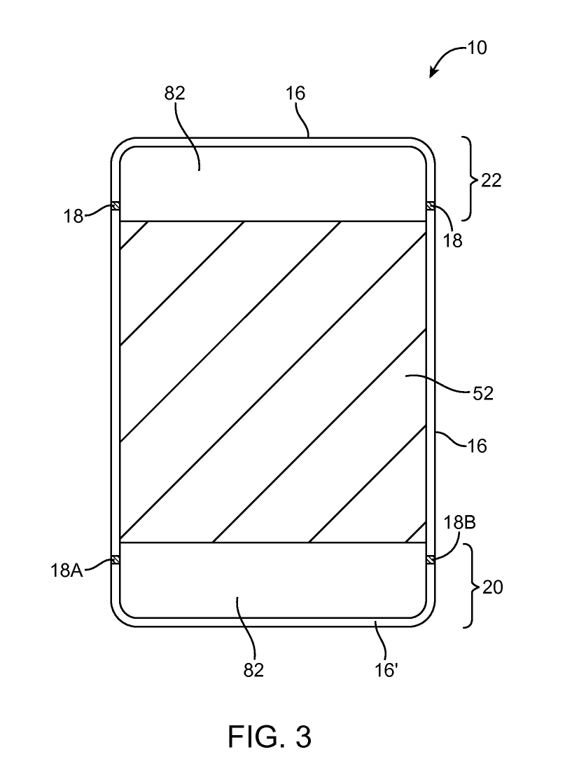

A top interior view of device 10 in a configuration in which device 10 has a peripheral conductive housing member such as housing member 16 of FIG. 1 with one or more gaps 18 is shown in FIG. 3. As shown in FIG. 3, device 10 may have an antenna ground plane such as antenna ground plane 52. Ground plane 52 may be formed from traces on printed circuit boards (e.g., rigid printed circuit boards and flexible printed circuit boards), from conductive planar support structures in the interior of device 10, from conductive structures that form exterior parts of housing 12, from conductive structures that are part of one or more electrical components in device 10 (e.g., parts of connectors, switches, cameras, speakers, microphones, displays, buttons, etc.), or other conductive device structures. Gaps such as gaps 82 may be filled with air, plastic, or other dielectric.

One or more segments of peripheral conductive member 16 may serve as antenna resonating elements such as antenna resonating element 50 of FIG. 3. For example, the uppermost segment of peripheral conductive member 16 in region 22 may serve as an antenna resonating element for an upper antenna in device 10 and the lowermost segment of peripheral conductive member 16 in region 20 (i.e., segment 16′, which extends between gap 18A and gap 18B) may serve as an antenna resonating element for a lower antenna in device 10. The conductive materials of peripheral conductive member 16, the conductive materials of ground plane 52, and dielectric openings 82 (and gaps 18) may be used in forming one or more antennas in device 10 such as an upper antenna in region 22 and a lower antenna in region 20. Configurations in which an antenna in lower region 20 is implemented using a tunable frequency response configuration are sometimes described herein as an example.

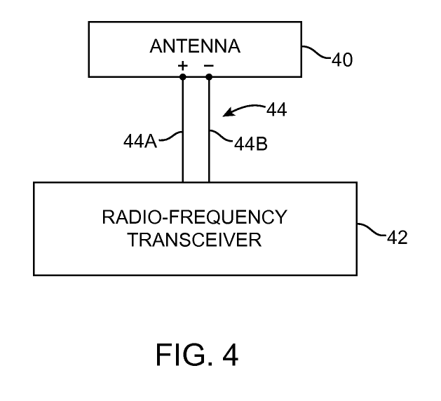

FIG. 4 is a diagram showing how a radio-frequency signal path such as path 44 may be used to convey radio-frequency signals between antenna 40 and radio-frequency transceiver 42. Antenna 40 may be one of antennas 40 of FIG. 2. Radio-frequency transceiver 42 may be a receiver and/or transmitter in wireless communications circuitry 34 (FIG. 3) such as receiver 35, wireless local area network transceiver 36 (e.g., a transceiver operating at 2.4 GHz, 5 GHz, 60 GHz, or other suitable frequency), cellular telephone transceiver 38, or other radio-frequency transceiver circuitry for receiving and/or transmitting radio-frequency signals.

Signal path 44 may include one or more transmission lines such as one or more segments of coaxial cable, one or more segments of microstrip transmission line, one or more segments of stripline transmission line, or other transmission line structures. Signal path 44 may include a positive conductor such as positive signal line 44A and may include a ground conductor such as ground signal line 44B. Antenna 40 may have an antenna feed with a positive antenna feed terminal (+) and a ground antenna feed terminal (−). If desired, circuitry such as filters, impedance matching circuits, switches, amplifiers, and other circuits may be interposed within path 44.

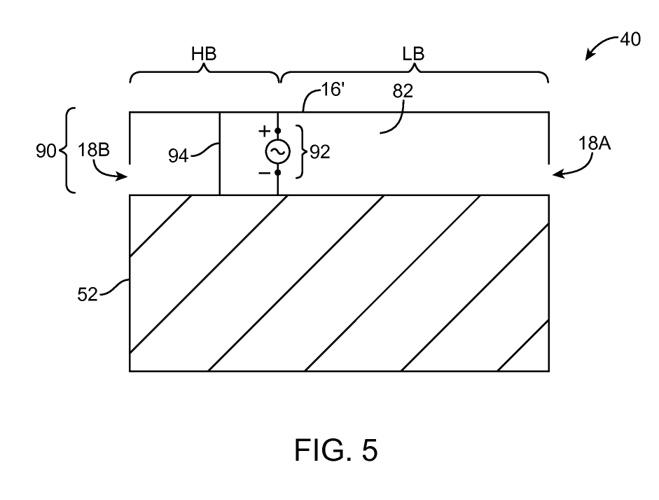

FIG. 5 is a diagram showing how structures such as peripheral conductive member segment 16′ of FIG. 3 may be used in forming antenna 40. In the illustrative configuration of FIG. 5, antenna 40 includes antenna resonating element 90 and antenna ground 52. Antenna resonating element may have a main resonating element arm formed from peripheral conductive member 16′ (e.g., a segment of peripheral conductive member 16 of FIG. 1). Gaps such as gaps 18A and 18B may be interposed between the ends of resonating element arm 16′ and ground 52. Short circuit branch 94 may be coupled between arm 16′ and ground 52. Antenna feed branch 92 may be coupled between arm 16′ and ground 52 in parallel with short circuit branch 94. Antenna feed branch 92 may include a positive antenna feed terminal (+) and a ground antenna feed terminal (−). As described in connection with FIG. 4, lines 44A and 44B in signal path 44 may be respectively coupled to terminals (+) and (−) in antenna feed 92.

Resonating element arm 16′ may have a longer portion (LB) that is associated with a low band resonance and that can be used for handling low band wireless communications. Resonating element arm 16′ may also have a shorter portion (HB) that is associated with a high band resonance and that can be used for handling high band wireless communications. The low band portion of arm 16′ may, for example, be used in handling signals at frequencies of 700 MHz to 960 MHz (as an example). The high band portion of arm 16′ may, for example, be used in handling signals at frequencies of 1710 MHz to 2200 MHz (as an example). These are merely illustrative low band and high band frequencies of operation for antenna 40. Antenna 40 may be configured to handle any suitable frequencies of interest for device 10.

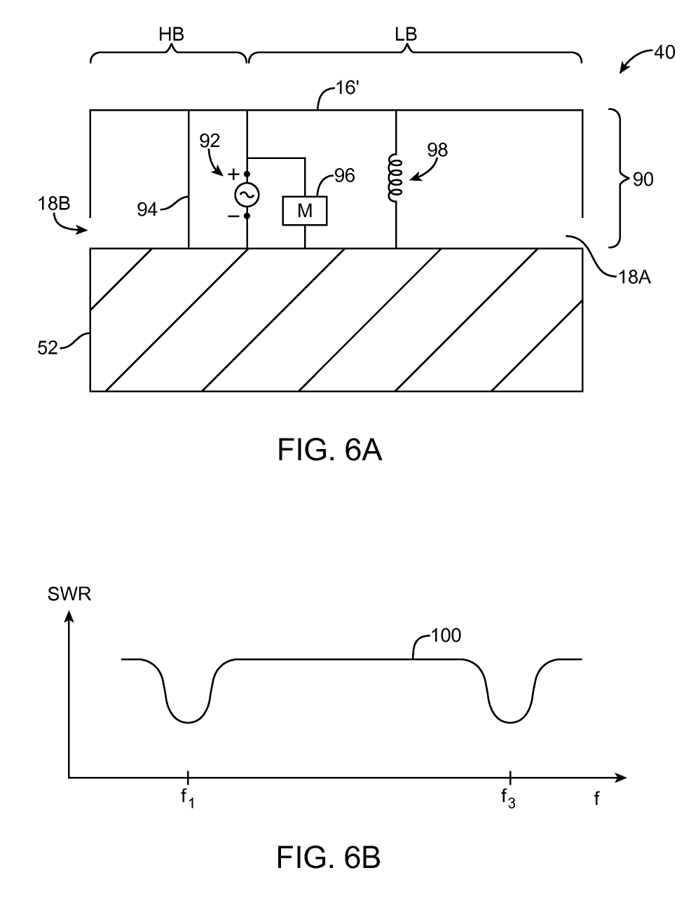

FIG. 6A shows how antenna 40 may be provided with an impedance matching circuit such as impedance matching circuit 96. Matching circuit 96 may be formed from a network or one or more electrical components (e.g., resistors, capacitors, and/or inductors) and may be configured so that antenna 40 exhibits a desired frequency response (e.g., so that antenna 40 covers desired communications bands of interest). As an example, matching circuit 96 may include an inductor coupled in parallel with feed 92 and/or additional electrical components.

As shown in FIG. 6A, impedance matching circuit 96 may be coupled between antenna resonating element arm 16′ and antenna ground 52 in parallel with antenna feed branch 92. Short circuit branch 94 may be coupled in parallel with feed branch 92 between resonating element arm 16′ and ground (e.g., on the high band side of feed 92, which is to the left of feed 92 in the illustrative configuration of FIG. 6A). Shunt inductor 98 may also be coupled in parallel with antenna feed branch 92 between arm 16′ and ground 52 (e.g., on the low band side of feed 92, which is to the right of feed 92 in the illustrative configuration of FIG. 6A).

The antenna configuration of FIG. 6A may be characterized by a performance curve such as standing-wave-ratio versus frequency curve 100 of FIG. 6B. As shown in FIG. 6B, antenna 40 of FIG. 6A may be characterized by a low band resonance centered at a frequency f1 (e.g., a resonance produced using portion LB of antenna 40 of FIG. 6A) and may be characterized by a high band resonance at frequency f3 (e.g., a resonance produced using portion HB of antenna 40 of FIG. 6A).

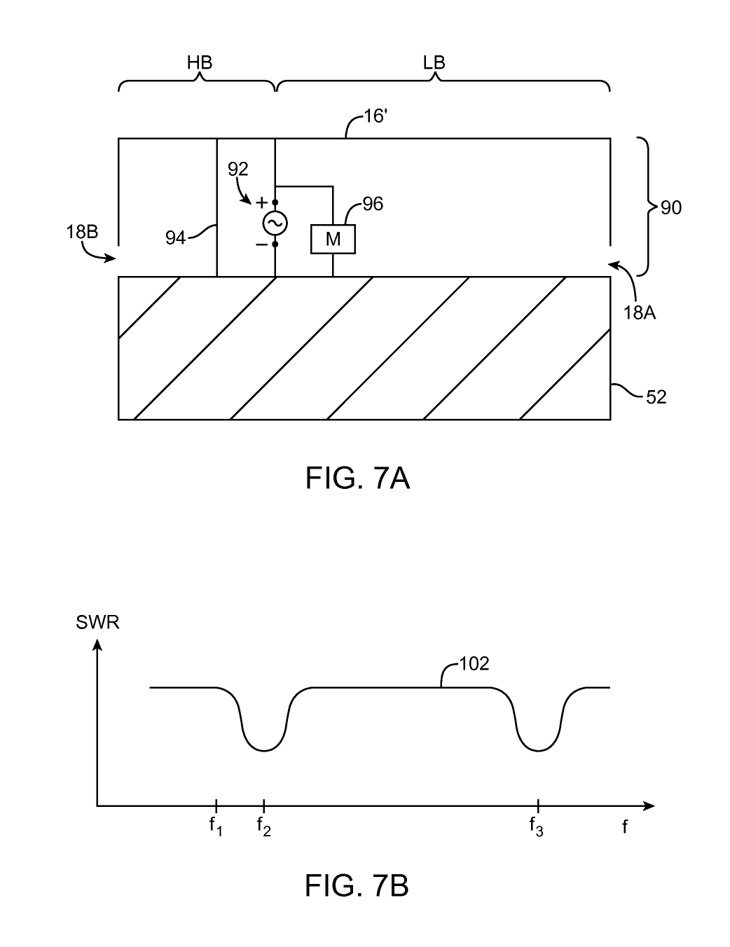

The low band resonance of curve 100 at frequency f1 may not be sufficiently wide to cover all low band frequencies of interest. FIG. 7A shows how antenna 40 of FIG. 6A may be modified so that the low band resonance cover a different set of low band frequencies. In the illustrative configuration of FIG. 7A, shunt inductor 98 of FIG. 6A has been removed. The antenna configuration of FIG. 7A may be characterized by a performance curve such as standing-wave-ratio versus frequency curve 102 of FIG. 7B. As shown in FIG. 7B, antenna 40 of FIG. 7A may be characterized by a low band resonance centered at a frequency f2 (e.g., a resonance produced using portion LB of antenna 40 of FIG. 6A that is higher in frequency than frequency f1). The high band resonance of antenna 40 of FIG. 7A may cover the same high band frequencies as antenna 40 of FIG. 6A (as an example).

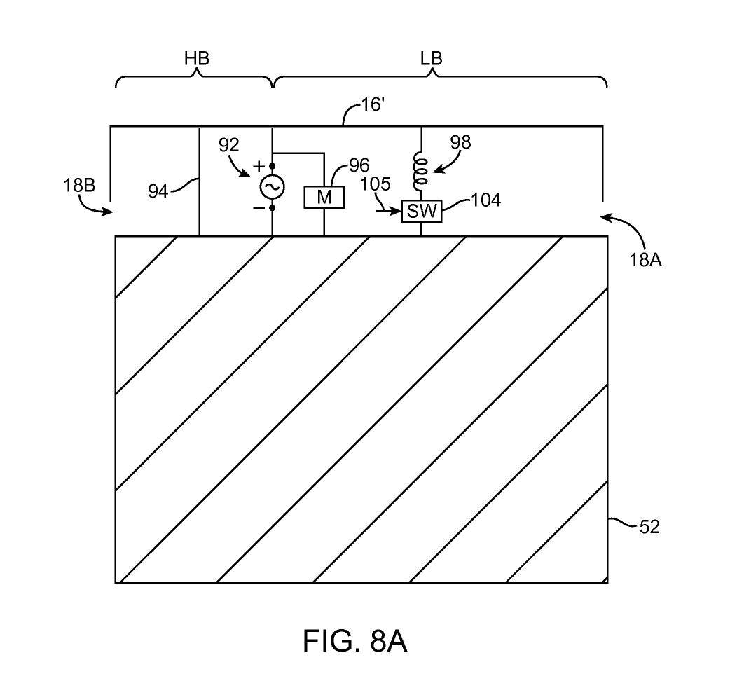

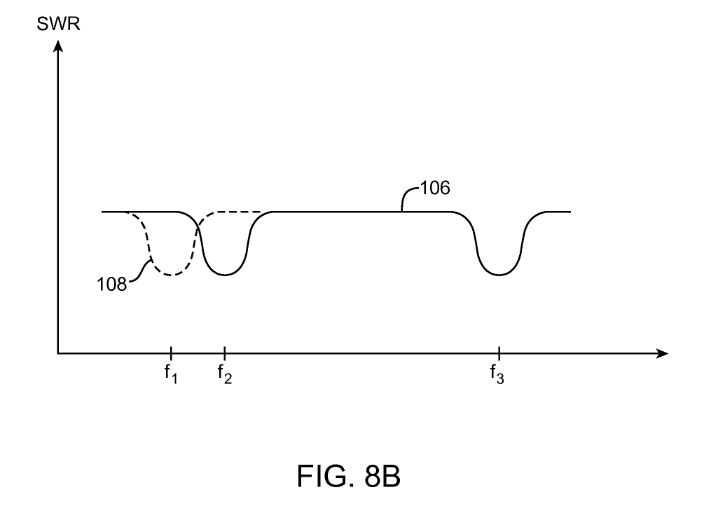

It may be desirable to cover both the low frequency band at frequency f1 (FIG. 6B) and the low frequency band at frequency f2 (FIG. 7B) in device 10. This can be accomplished by providing antenna 40 with switching circuitry such as switch 104 of FIG. 8A. As shown in FIG. 8A, short circuit branch 94 may be coupled between antenna resonating element arm 16′ and antenna ground 52 at a first location along the length of antenna resonating element arm 16′. Switch 104 and inductor 98 may be coupled in series and may be used to form an adjustable inductor circuit that is coupled between antenna resonating element arm 16′ and antenna ground 52 at a second location along the length of antenna resonating element arm 16′. Antenna feed branch 92 may be coupled between antenna resonating element arm 16′ and antenna ground 52 at a third location along the length of antenna resonating element arm 16′ interposed between the short circuit branch at the first location and the series-connected inductor and switch and the second location.

As shown in FIG. 8A, switch 104 may be provided with control signals at control input 105 from control circuitry 28 (FIG. 2). The control signals may be adjusted in real time to control the frequency response of antenna 40. For example, when it is desired to configure antenna 40 of FIG. 8A to cover the communications band at frequency f1 of FIG. 6B, switch 104 may be placed in its closed state. When switch 104 is closed, inductor 98 will be electrically coupled between resonating element arm 16′ and ground 52, so that antenna 40 of FIG. 8A will have a configuration of the type shown in FIG. 6A. When switch 104 is placed in its open state, an open circuit will be formed that electrically decouples inductor 98 from antenna 40 of FIG. 8A. With inductor 98 switched out of use in this way, antenna 40 of FIG. 8A will have a configuration of the type shown in FIG. 7A.

The antenna configuration of FIG. 8A may be characterized by a performance curve such as standing-wave-ratio versus frequency curve 106 of FIG. 8B. As shown in FIG. 8B, antenna 40 of FIG. 8A may be characterized by a low band resonance centered at a frequency f1 (curve 108) when switch 104 is closed and may be characterized by a low band resonance centered at a frequency f2 (curve 106) when switch 104 is open. The high band resonance at frequency f3 may be relatively unaffected by the position of switch 104 (i.e., the high band resonance of antenna 40 of FIG. 8A may cover a communications band centered at frequency f3 when switch 104 is in its open position and when switch 104 is in its closed position).

The frequency bands associated with antenna 40 of FIGS. 8A and 8B may correspond to wireless local area network bands, satellite navigation bands, television bands, radio bands, cellular telephone bands, or other communications band of interest. For example, the communications band associated with frequency f1 may extend from about 700 to 820 MHz and may be used to handle Long Term Evolution (LTE) cellular telephone communications, the communications band associated with frequency f2 may extend from about 820 to 960 MHz and may be associated with Global System for Mobile Communications (GSM) cellular telephone communications, Universal Mobile Telecommunications System (UMTS) cellular telephone communications, and/or optional LTE cellular telephone communications, and the communications band associated with frequency f3 may extend from about 1710 to 2200 MHz and may be used in handling GSM, LTE, and/or UMTS cellular telephone communications (as examples). Other types of communications traffic may be handled using antenna 40 of FIG. 8A if desired. These are merely illustrative examples.

The foregoing is merely illustrative of the principles of this invention and various modifications can be made by those skilled in the art without departing from the scope and spirit of the invention.

What is claimed is:

1. An electronic device, comprising:
control circuitry; and
an antenna having an antenna resonating element arm and an antenna ground configured to resonate in at least a first communications band and a second communications band that is higher in frequency than the first communications band, having an inductor, and having a switch, wherein the inductor and switch are coupled in series between antenna resonating element arm and the antenna ground, wherein the switch is configured to switch between an open state and a closed state in response to control signals from the control circuitry, and wherein the antenna is configured to resonate in a lower frequency portion of the first communications band and in the second communications band in response to placing the switch in the closed state and wherein the antenna is configured to resonate in a higher frequency portion of the first communications band and in the second communications band in response to placing the switch in the open state.

2. The electronic device defined in claim 1 wherein the antenna comprises an antenna feed branch coupled between the antenna resonating element arm and the antenna ground.

3. The electronic device defined in claim 2 further comprising a cellular telephone transceiver coupled to the antenna at the antenna feed branch.

4. The electronic device defined in claim 3 further comprising a short circuit branch coupled between the antenna resonating element arm and the antenna ground.

5. The electronic device defined in claim 4 wherein the antenna feed branch is interposed between the short circuit branch and the inductor and switch that are coupled in series.

6. The electronic device defined in claim 5 further comprising:
a housing containing conductive structures that form the antenna ground for the antenna and having a peripheral conductive member that runs around at least some edges of the housing, wherein a segment of the peripheral conductive member forms the antenna resonating element arm for the antenna.

7. The electronic device defined in claim 1 wherein the antenna resonating element arm has a longer portion that resonates in the first communications band and a shorter portion that resonates in the second communications band.

8. The electronic device defined in claim 7 further comprising:
a housing containing conductive structures that form the antenna ground for the antenna and having a peripheral conductive member that runs around at least some edges of the housing, wherein a segment of the peripheral conductive member forms the antenna resonating element arm for the antenna.

9. The electronic device defined in claim 1 further comprising:
a housing containing conductive structures that form the antenna ground for the antenna and having a peripheral conductive member that runs around at least some edges of the housing, wherein a segment of the peripheral conductive member forms the antenna resonating element arm for the antenna.

10. An antenna, comprising:
an antenna resonating element arm;
an antenna ground;
a series-connected inductor and switch coupled between the resonating element arm and the antenna ground;
a short circuit branch coupled between the antenna resonating element arm and the antenna ground; and
an antenna feed coupled between the antenna resonating element arm and the antenna ground at a location along the antenna resonating element arm that is between the short circuit branch and the series-connected inductor and switch.

11. The antenna defined in claim 10 wherein the antenna is configured to resonate in a lower frequency portion of a first communications band and in a second communications band that is at higher frequencies than the first communications band in response to placing the switch in a closed state and wherein the antenna is configured to resonate in a higher frequency portion of the first communications band and in the second communications band in response to placing the switch in an open state.

12. The antenna defined in claim 11 wherein the antenna resonating element arm comprises a segment of a peripheral conductive member in an electronic device housing.

13. The antenna defined in claim 12 wherein the antenna resonating element arm is configured to handle cellular telephone signals.

14. The electronic device defined in claim 13 wherein the antenna resonating element arm has a longer portion that resonates in the first communications band and a shorter portion that resonates in the second communications band.

15. The antenna defined in claim 14 further comprising an impedance matching circuit coupled in parallel with the antenna feed.

16. The electronic device defined in claim 11 wherein the antenna resonating element arm has a longer portion that resonates in the first communications band and a shorter portion that resonates in the second communications band.

17. An antenna, comprising:
an antenna resonating element arm that has a longer portion that resonates in a first communications band and a shorter portion that resonates in a second communications band that is associated with higher frequencies than the first communications band;
an antenna ground;
a series-connected inductor and switch coupled between the resonating element arm and the antenna ground;
a short circuit branch coupled between the antenna resonating element arm and the antenna ground; and
an antenna feed coupled between the antenna resonating element arm and the antenna ground.

18. The antenna defined in claim 17 wherein the antenna feed is coupled between the antenna resonating element and the antenna ground at a location along the antenna resonating element arm that is between the short circuit branch and the series-connected inductor and switch.

19. The antenna defined in claim 18 wherein the short circuit branch is coupled between the shorter portion of the antenna resonating element and the antenna ground.

20. The antenna defined in claim 19 wherein the series-connected inductor and switch are coupled between the longer portion of the antenna resonating element arm and the antenna ground.

21. The antenna defined in claim 20 wherein the antenna resonating element arm comprises a segment of a peripheral conductive member in an electronic device housing.
